(19) United States
(12) Patent Application Publication
(10) Pub. No.: US 2016/0305380 A1
(43) Pub. Date: Oct. 20, 2016

(54) THROTTLE BODY ADAPTER PLATES AND METHODS OF USING THE SAME

(71) Applicants: Jacob Alexander Justice, Lubbock, TX (US); Joshua Jason Bloys, Lubbock, TX (US)

(72) Inventors: Jacob Alexander Justice, Lubbock, TX (US); Joshua Jason Bloys, Lubbock, TX (US)

(21) Appl. No.: 15/132,204

(22) Filed: Apr. 18, 2016

Related U.S. Application Data
(60) Provisional application No. 62/149,513, filed on Apr. 17, 2015.

(51) Int. Cl. F02M 35/10

(52) U.S. Cl. CPC F02M 35/10354; F02M 35/10019

(57) ABSTRACT

Disclosed herein are devices and methods of use directed to automotive throttle body adapter plates with various bolt patterns. In one embodiment, the throttle body adapter plate is comprised of a main body element configured with a bolt pattern on one end to connect to an automobile's intake manifold and further configured at the opposing end with another bolt pattern to connect to an automobile's throttle body. In another embodiment, the internal airflow shape or profile is configured for optimal flow having an outside inlet diameter and tapering down to the intake manifold outlet diameter.

### CROSS-REFERENCE TO RELATED APPLICATIONS

This application claims the benefit under Title 35 United States Code § 119(e) of U.S. Provisional Patent Application Ser. No.: 62/149,513; Filed: Apr. 17, 2015, the full disclosure of which is incorporated herein by reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention generally relates to devices and methods of use directed to adapter plates. More specifically, the present invention relates to devices and methods of use directed to automotive throttle body adapter plates with various bolt patterns.

### BACKGROUND OF THE INVENTION

Without limiting the scope of the disclosed apparatus and methods, the background is described in connection with novel throttle body adapter plates.

Throttle bodies are part of the air intake system that controls the amount of air flowing into the engine, in response to the driver accelerator pedal input. The throttle body is usually located between the air filter box and the intake manifold.

An upgrade often performed on automobiles is replacing the originally equipped throttle body with a larger bore throttle body. This is performed to increase the throttle response, horsepower and torque by increasing and optimizing the airflow to the engine.

An issue that often arises is that the bolt patterns for the larger throttle bodies will not directly bolt up to the factory bolt pattern on the intake manifold. As a specific example, the larger 70-75 mm Hitachi throttle bodies will not bolt up to the factory 65×65 mm bolt pattern found on intake manifold, such as those originally equipped on the HR, VHR, and VR engine series.

One approach used in the prior art is to bore the stock units out so that the bolt pattern does not need to be altered, however this can only be taken so far on any given housing due to physical limitations. Another approach used in the prior art for VR engines is an aftermarket billet 68 mm bore housing retrofitted with stock internals and electronics.

While all of the aforementioned approaches and designs may fulfill their unique purposes, none of them fulfill the need for a practical, efficient, and effective means for providing a throttle body adapter plate that can be used with various bolt patterns without modifications to existing components.

The present invention therefore proposes novel devices and methods of use directed to automotive throttle body adapter plates with various bolt patterns.

### BRIEF SUMMARY OF THE INVENTION

The present invention, therefore, provides devices and methods of use directed to automotive throttle body adapter plates with various bolt patterns.

In one embodiment, the throttle body adapter plate is comprised of a main body element configured with a bolt pattern on one end to connect to an automobile's intake manifold and further configured at the opposing end with another bolt pattern to mate with the automobile's throttle body.

In an embodiment, the bolt pattern to connect to the automobile's manifold is a 65×65 mm bolt pattern and the bolt pattern to connect to the throttle body is a 65×80 mm pattern.

In another embodiment, the bolt pattern to connect to the automobile's manifold is a 65×65 mm bolt pattern and the bolt pattern to connect to the throttle body is a 60×70 mm pattern.

In another embodiment, the internal airflow shape or profile is configured for optimal flow having an outside inlet diameter and tapering down to the manifold inlet diameter. In an embodiment, this configuration for optimal flow is a gradually tapered profile to smooth out the airflow into the plenum. In a further embodiment, the configuration for optimal flow is a specific profile as disclosed herein.

In another embodiment, the external shape is configured to support various bolt patterns.

In summary, the present invention discloses devices and methods of use directed to adapter plates. More specifically, the present invention relates to devices and methods of use directed to automotive throttle body adapter plates with various bolt patterns.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a back perspective view of a throttle body adapter plate in accordance with embodiments of the disclosure;

FIG. 2 is a back view of a throttle body adapter plate in accordance with embodiments of the disclosure;

FIG. 3 is a front view of a throttle body adapter plate in accordance with embodiments of the disclosure;

FIG. 4 is a left side view of a throttle body adapter plate in accordance with embodiments of the disclosure;

FIG. 5 is a right side view of a throttle body adapter plate in accordance with embodiments of the disclosure;

FIG. 6 is a top view of a throttle body adapter plate in accordance with embodiments of the disclosure;

FIG. 7 is a bottom view of a throttle body adapter plate in accordance with embodiments of the disclosure;

FIG. 8 is a cross-sectional view of a throttle body adapter plate in accordance with embodiments of the disclosure;

FIG. 9 is a back perspective view of a throttle body adapter plate with the gasket removed in accordance with embodiments of the disclosure;

FIG. 10 is an environmental view showing an installation of a throttle body adapter plate in accordance with embodiments of the disclosure;

FIG. 11 is an internal air profile of a 71-63 mm throttle body adapter plate in accordance with embodiments of the disclosure;

FIG. 12 is an internal air profile of a 71-67 mm throttle body adapter plate in accordance with embodiments of the disclosure;

FIG. 13 is an internal air profile of a 76-75.5 mm throttle body adapter plate in accordance with embodiments of the disclosure.

### DETAILED DESCRIPTION OF THE INVENTION

Disclosed herein are automotive throttle body adapter plate and methods of use. The numerous innovative teachings of the present invention will be described with particular reference to several embodiments (by way of example, and not of limitation).

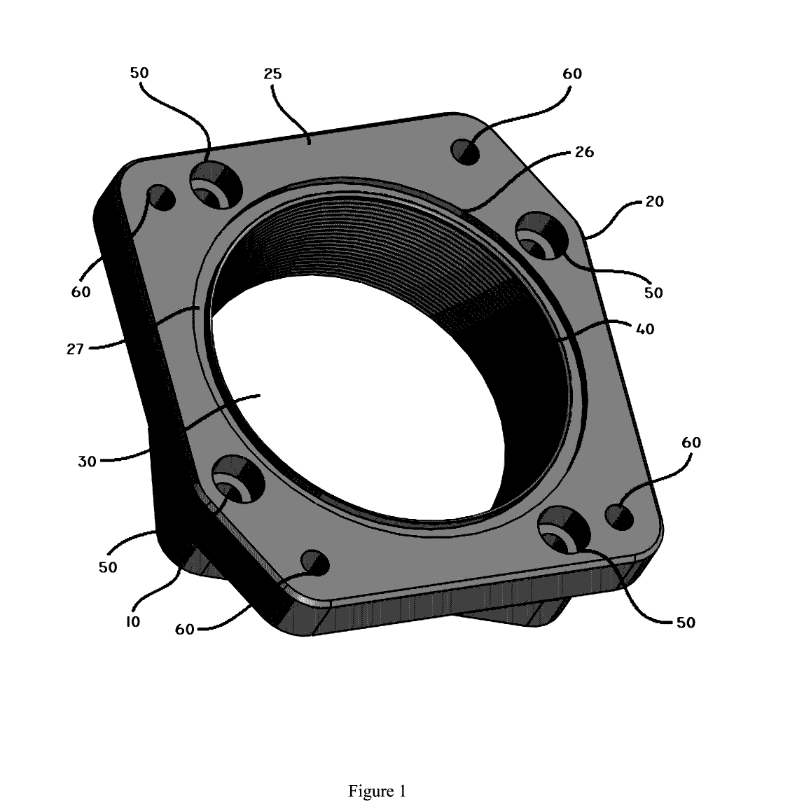

Reference is first made to FIG. 1, a back perspective view of a throttle body adapter plate in accordance with embodiments of the disclosure. In one embodiment, the throttle body adapter plate is comprised of a main body element 10 configured with a bolt pattern 50 on one end to connect to an automobile's intake manifold (front portion or face) and further configured at the opposing end (back portion or face 25) with another bolt pattern 60 to connect to an automobile's throttle body. In an embodiment, the opposing end (back portion or face 25) is a portion or formed as part of a flange 20 that surrounds the entire opposing end (back portion or face 25).

In an embodiment, the bolt pattern to connect to the automobile's manifold is a 65×65 mm bolt pattern and the bolt pattern to connect to the throttle body is either a 65×80 mm or a 60×70 mm pattern. These dimensions are based on the bolt hole centerline. The actual bolt pattern of the plate can vary with respect to the throttle body bolt hole pattern slightly such that better alignment of the throttle body bore on the adapter plate bore 30 is obtained. By relocating the bolts 60 to the corners of the throttle body bolt holes as opposed to the centers, the throttle body is pulled into place on the bore 30 centerline of the plate. In other embodiments, the bolt patterns that adapt the throttle body to the application are configured for a particular throttle body. In an embodiment, the bolt pattern configured for the throttle body is for use with a Hitachi 70 mm electronic throttle body. In another embodiment, the bolt pattern is configured for use with a Hitachi 75 mm electronic throttle body. This also includes but is not limited to the Hitachi ETB0013, ETB0014, and the ETB0021.

The larger holes 50 are the bolt patterns 50 configured for the automobile's intake manifold and the smaller threaded holes 60 are the bolt patterns 60 configured for the automobile's throttle body.

FIG. 1 illustrates the view of the device on the side that connects to the automobiles throttle body.

Also illustrated is the bore hole 30, the gasket trough 26, the gasket 27, and the profile surface of the bore hole 40. The gasket 27 helps form a better fit or seal between the back portion or face 25 and the throttle body.

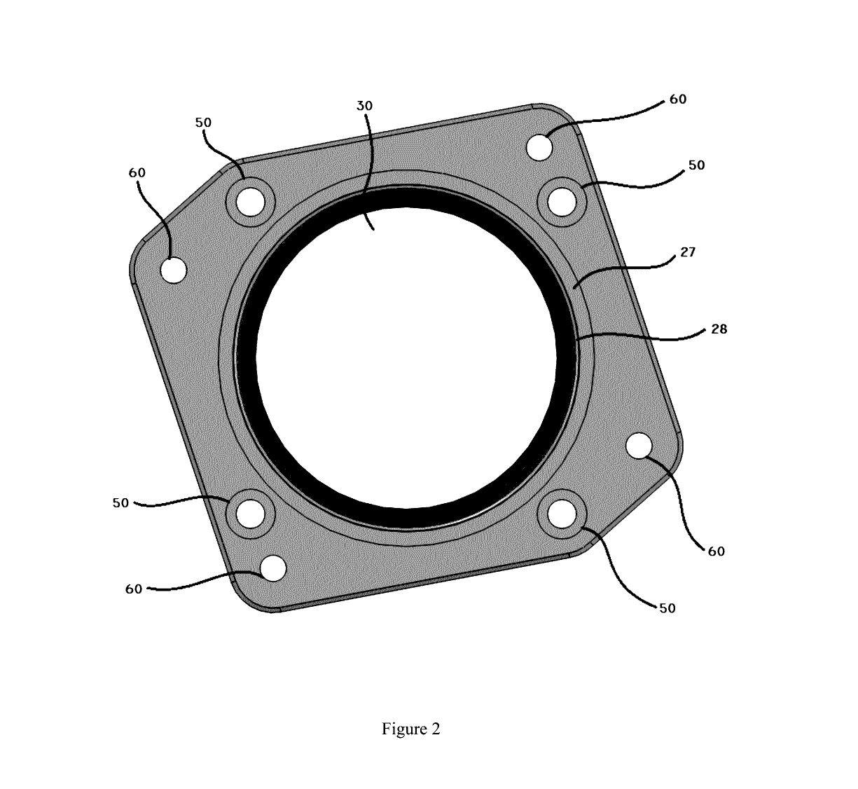

Reference is now made to FIG. 2, a back view of a throttle body adapter plate in accordance with embodiments of the disclosure. Illustrated here is the throttle body adapter plate back portion or face 25, which contains the bolt pattern face 60 for the throttle body. That is, this portion connects to the throttle body. In another embodiment, the external shape of the throttle body adapter plate is configured to support various bolt patterns. In this view also seen clearly is the outside or outer inlet diameter 28 of the bore hole 30. The top of the outside or outer inlet diameter 28 of the bore hole 30 tapers, or is filleted, to the back portion or face 25 before forming the gasket trough 26. That is, when the throttle body is bolted to the adapter plate, there is no sharp corner or edge obstructing airflow through the throttle body due to bore misalignment at the outside or outer inlet diameter 28 of the bore hole 30 and the back portion or face 25. This allows for a better fit between the throttle body adapter plate's back portion or face 25 and the throttle body. This also ensures that the end user can bolt the throttle body to the plate blindly without accidentally forming airflow restrictions, and most importantly, without removing the intake manifold to line the throttle body up with the plate. The design feature also allows a slightly over-bored throttle body to be installed using the existing plate designed for the standard bore diameter units.

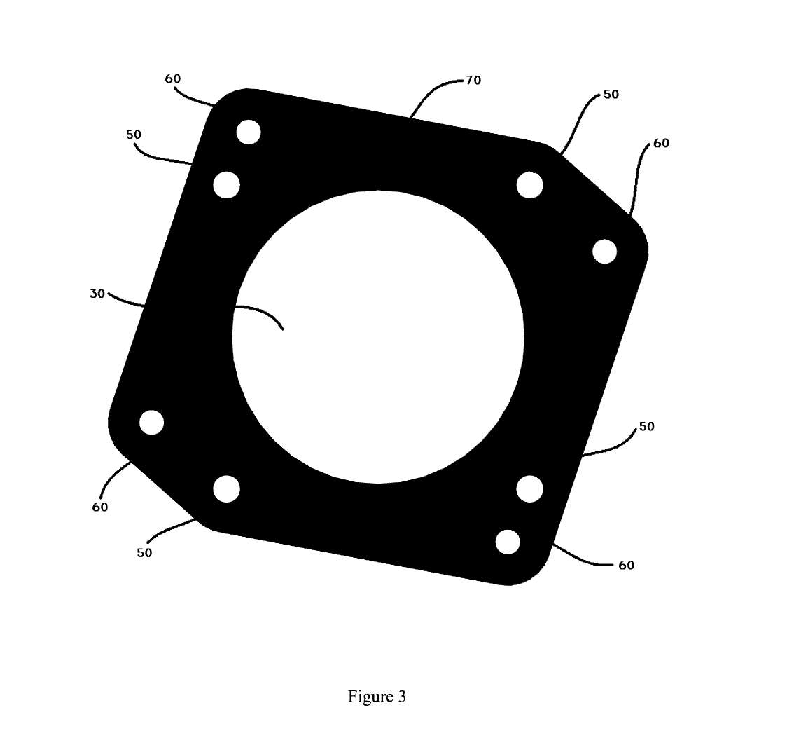

Reference is next made to FIG. 3, a front view of a throttle body adapter plate in accordance with embodiments of the disclosure. Illustrated here is the throttle body adapter plate front portion or face 70 which contains the bolt pattern 50 face for the intake manifold. That is, this portion connects to the intake manifold. In another embodiment, the external shape of the throttle body adapter plate is configured to support various bolt patterns. In this view also seen clearly is the manifold inlet diameter of the bore hole 30.

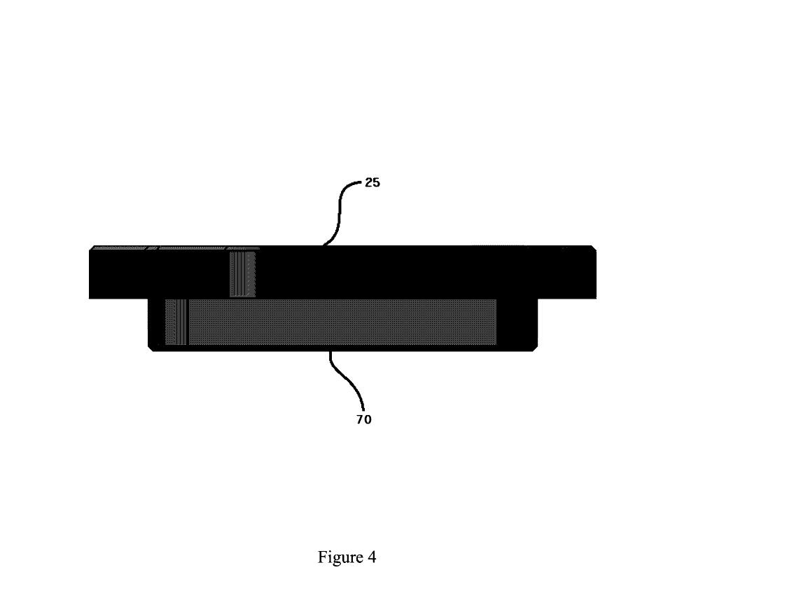

Reference is now made to FIG. 4, a left side view of a throttle body adapter plate in accordance with embodiments of the disclosure. The top of this illustration is the back portion or portion face 25 that connects to the throttle body and the bottom of this illustration is the front portion or portion face 70 that connects to the intake manifold. The direction of the airflow is from the top to the bottom of this illustration.

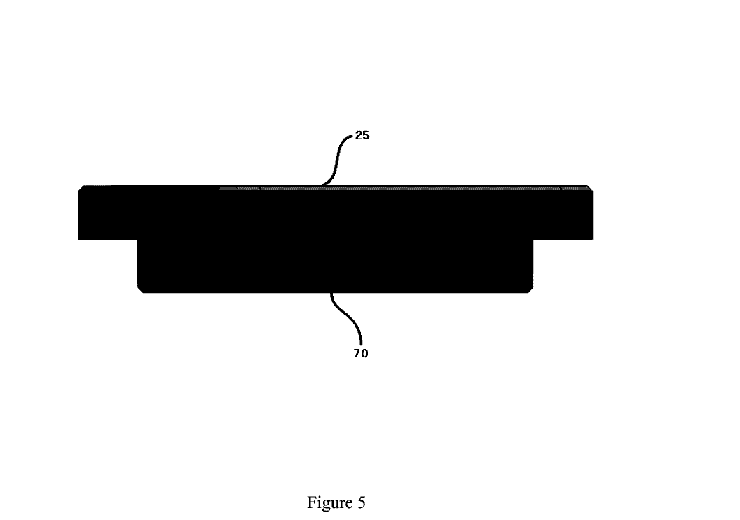

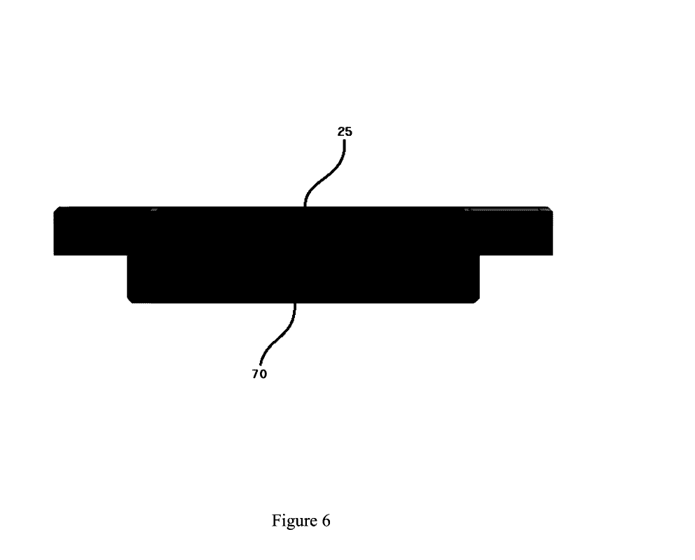

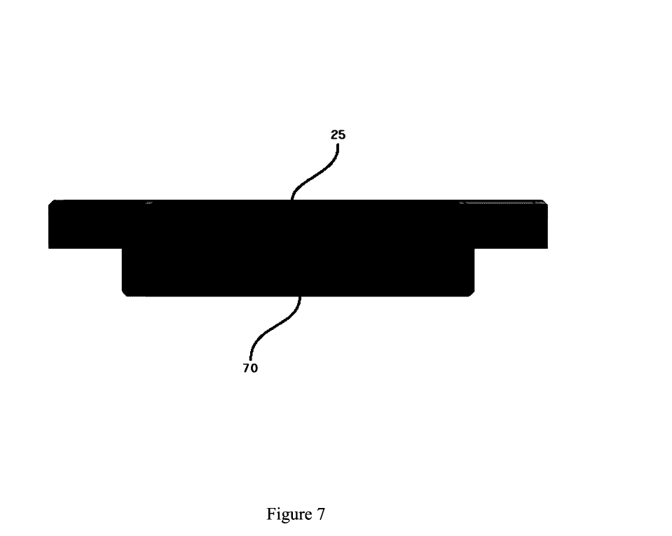

Reference is next made to FIG. 5, FIG. 6, and FIG. 7 a right, top, and bottom side (respectively) view of a throttle body adapter plate in accordance with embodiments of the disclosure. These views provide an all around view of the shape, structure, and configuration of the throttle body adapter plate in an embodiment.

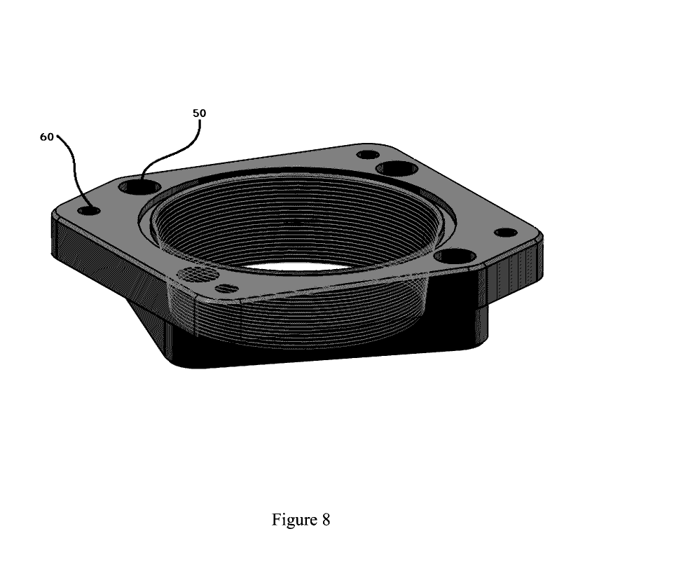

Reference is now made to FIG. 8, a cross-sectional view of a throttle body adapter plate in accordance with embodiments of the disclosure. Illustrated here is the internal airflow shape or profile for managing the airflow from the throttle body to the intake manifold. This internal airflow shape or profile for managing the airflow from the throttle body to the intake manifold may also be referred to as the profile surface of the bore hole 40.

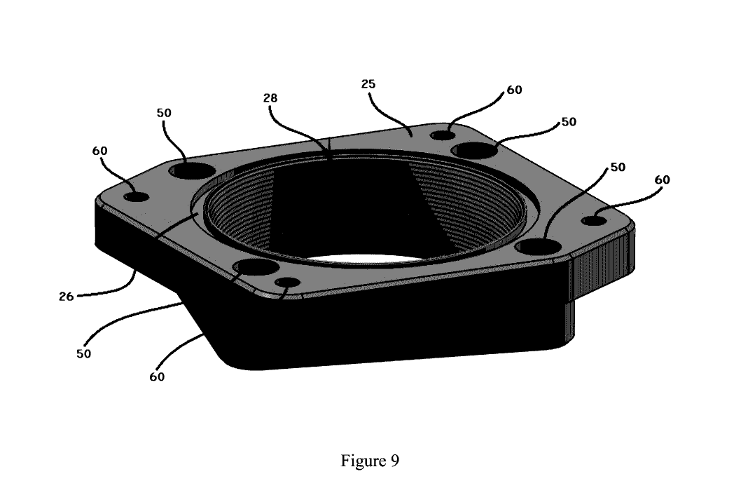

Reference is next made to FIG. 9, a back perspective view of a throttle body adapter plate with the gasket removed in accordance with embodiments of the disclosure. More clearly illustrated here is the gasket trough 26. In this illustration, the gasket 27 has been removed.

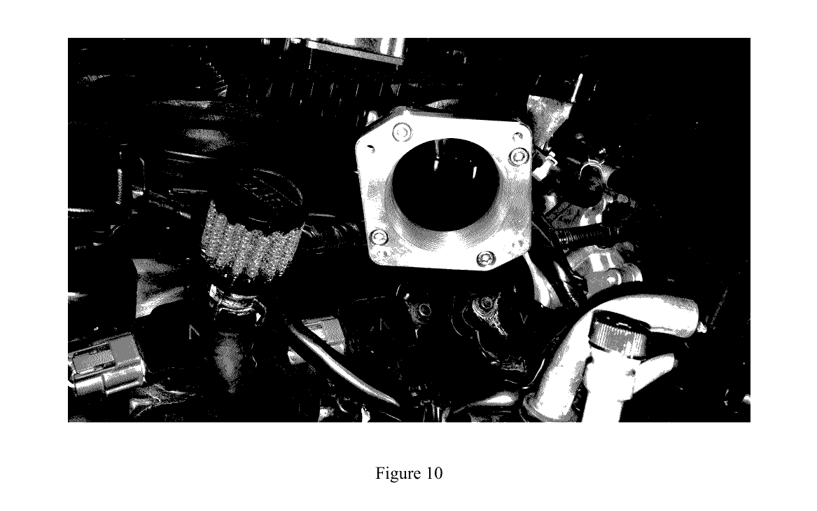

Reference is now made to FIG. 10, an environmental view showing an installation of a throttle body adapter plate in accordance with embodiments of the disclosure. Illustrated here are the large bolt pattern holes 50 being utilized to connect the throttle body adapter plate to the intake manifold. The throttle body is not connected to the adapter plate in this illustration.

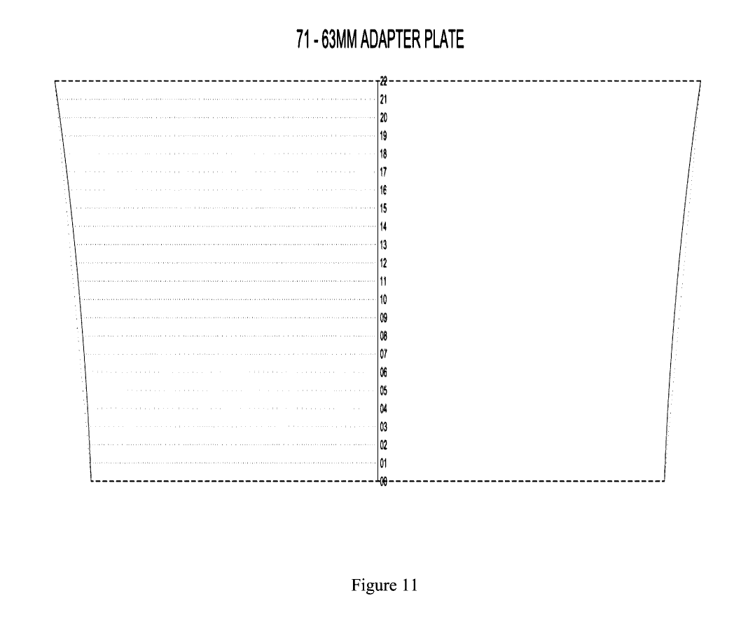

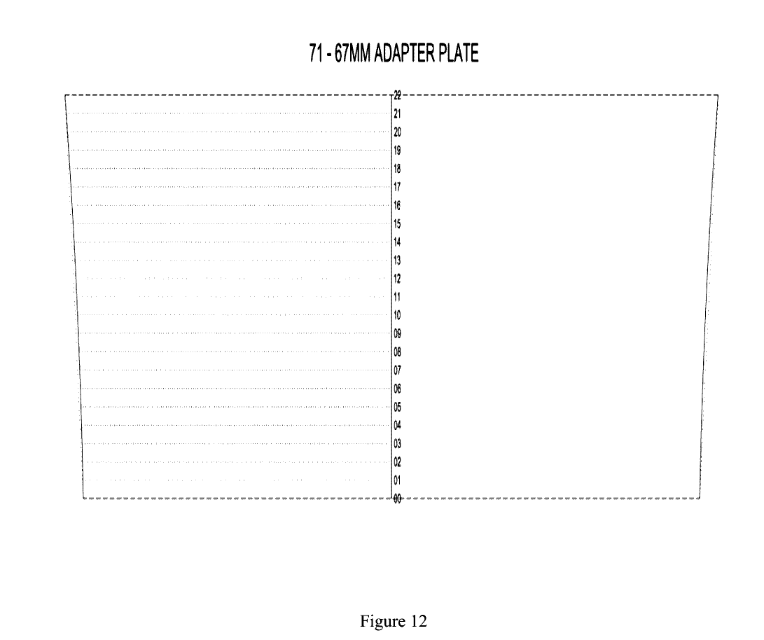

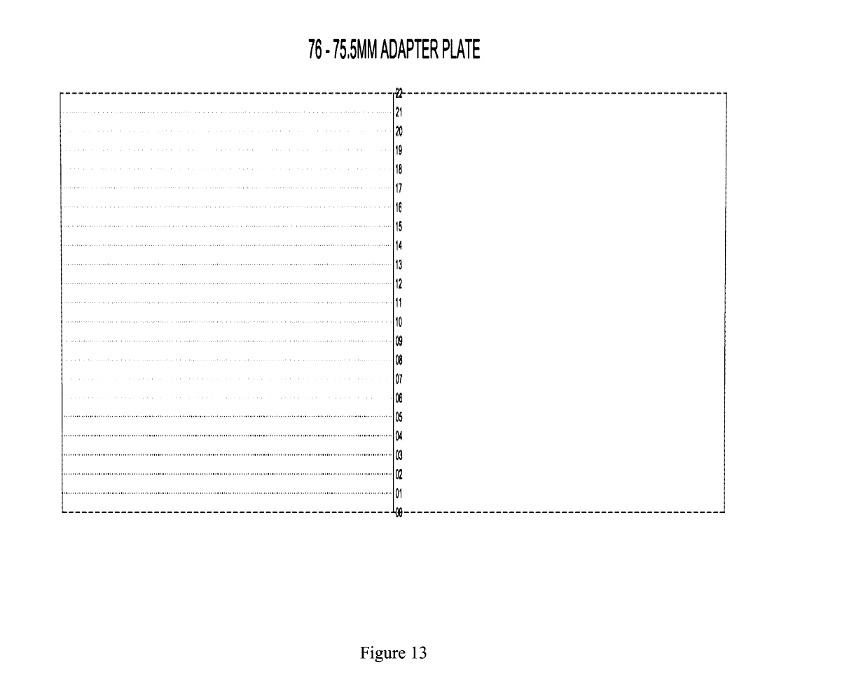

Reference is lastly made to FIGS. 11, 12, and 13 an internal air profile of a 71-63 mm, 71-67 mm, and a 76-75.5 mm (respectively) throttle body adapter plate in accordance with embodiments of the disclosure. In an embodiment, the internal airflow shape or profile is configured for optimal flow having an outside inlet diameter and tapering down to the manifold inlet diameter. In an embodiment, this configuration for optimal flow is a gradually tapered profile to smooth out the airflow into the plenum. In a further embodiment, the configuration for optimal flow is a specific profile as disclosed herein. Illustrated in these figures are the layers along the y-axis of the throttle body adapter plate. Layer 00 is the front portion or front face of the throttle body adapter plate which connects to the intake manifold. Layer 22 is the back portion or back face of the throttle body adapter plate which connects to the throttle body. From layer 00 to layer 22 are layers 01-21 equally spaced. Table 1 provides the diameters in mm of the layers to establish the internal airflow shapes or profiles in embodiments of the throttle body adapter plate with the 76-75.5 mm configuration being profile 1, the 71-67 mm configuration being profile 2, and the 71-63 mm configuration being profile 3.

TABLE 1

| Layer | 76-75.5 mm | 71-67 mm | 71-63 mm |
|---|---|---|---|
| 22 | 38.000 | 35.500 | 35.500 |
| 21 | 37.982 | 35.359 | 35.218 |
| 20 | 37.965 | 35.223 | 34.945 |
| 19 | 37.949 | 35.091 | 34.682 |
| 18 | 37.933 | 34.965 | 34.429 |
| 17 | 37.918 | 34.843 | 34.286 |
| 16 | 37.903 | 34.726 | 33.953 |
| 15 | 37.889 | 34.614 | 33.729 |
| 14 | 37.876 | 34.507 | 33.514 |
| 13 | 37.863 | 34.405 | 33.310 |
| 12 | 37.851 | 34.307 | 33.114 |
| 11 | 37.839 | 34.214 | 32.929 |
| 10 | 37.828 | 34.126 | 32.752 |
| 9 | 37.818 | 34.043 | 32.585 |
| 8 | 37.808 | 33.964 | 32.428 |
| 7 | 37.799 | 33.890 | 32.279 |
| 6 | 37.790 | 33.820 | 32.140 |
| 5 | 37.782 | 33.755 | 32.011 |
| 4 | 37.774 | 33.695 | 31.890 |
| 3 | 37.767 | 33.639 | 31.779 |
| 2 | 37.761 | 33.588 | 31.677 |
| 1 | 37.755 | 33.542 | 31.584 |
| 0 | 37.750 | 35.500 | 31.500 |

In brief, as described herein provides for a device and methods of use directed to a throttle body adapter plate.

The disclosed device and methods are generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention.

Terms such as “a”, “an”, and “the” are not intended to refer to only a singular entity, but include the general class of which a specific example may be used for illustration. The terminology herein is used to describe specific embodiments of the invention, but their usage does not delimit the disclosed device or method, except as may be outlined in the claims.

Alternative applications for this invention include using the device and methods for various throttle body sizes requiring different bolt patterns. In addition, the disclosed throttle body adapter plates may be used for various machines including, but not limited to, boats, aircrafts, and machinery. Consequently, any embodiments comprising a one piece or multi piece device having the structures and/or components as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific device and methods described herein. Such equivalents are considered to be within the scope of this invention and are covered by the claims.

All publications, patents, and patent applications mentioned in the specification are indicative of the level of those skilled in the art to which this invention pertains. All publications, patents, and patent application are herein incorporated by reference to the same extent as if each individual publication, patent, or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The device and/or methods disclosed and claimed herein can be made and executed without undue experimentation in light of the present disclosure. While the device and methods of this invention have been described in terms of preferred embodiments, it will be apparent to those skilled in the art that variations may be applied to the device and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. An automotive throttle body adapter plate comprising:
a main body element configured with a bolt pattern on the front portion for connecting the automotive throttle body adapter plate to an automobile's intake manifold; also configured with a bolt pattern on the back portion for connecting the automotive throttle body adapter plate to a throttle body; and configured with a bore hole.

2. The automotive throttle body adapter plate of claim 1, further comprising a flange configured on said back portion of which said bolt pattern for connecting the automotive throttle body adapter plate to a throttle body pass through.

3. The automotive throttle body adapter plate of claim 1, further comprising a gasket trough configured on said back portion and a gasket residing in said gasket trough.

4. The automotive throttle body adapter plate of claim 2, further comprising a gasket trough configured on said back portion and a gasket residing in said gasket trough.

5. The automotive throttle body adapter plate of claim 2, wherein said bolt pattern on the front portion for connecting the automotive throttle body adapter plate to an automobile's intake manifold is a 65×65 mm bolt pattern.

6. The automotive throttle body adapter plate of claim 2, wherein said bolt pattern on the back portion for connecting the automotive throttle body adapter plate to a throttle body is a 65×80 mm bolt pattern.

7. The automotive throttle body adapter plate of claim 2, wherein said bolt pattern on the back portion for connecting the automotive throttle body adapter plate to a throttle body is a 60×70 mm bolt pattern.

8. The automotive throttle body adapter plate of claim 2, wherein said bolt pattern on the front portion for connecting the automotive throttle body adapter plate to an automobile's intake manifold is a 65×65 mm bolt pattern and wherein said bolt pattern on the back portion for connecting the automotive throttle body adapter plate to a throttle body is a 65×80 mm bolt pattern.

9. The automotive throttle body adapter plate of claim 2, wherein said bolt pattern on the front portion for connecting the automotive throttle body adapter plate to an automobile's intake manifold is a 65×65 mm bolt pattern and wherein said bolt pattern on the back portion for connecting the automotive throttle body adapter plate to a throttle body is a 60×70 mm bolt pattern.

10. The automotive throttle body adapter plate of claim 1, further comprising a rounded corner where the outside or inlet diameter of the bore hole and said back portion meet.

11. The automotive throttle body adapter plate of claim 2, further comprising a rounded corner where the outside or inlet diameter of the bore hole and said back portion meet.

12. The automotive throttle body adapter plate of claim 3, further comprising a rounded corner where the outside or inlet diameter of the bore hole and said back portion meet.

13. The automotive throttle body adapter plate of claim 4, further comprising a rounded corner where the outside or inlet diameter of the bore hole and said back portion meet.

14. The automotive throttle body adapter plate of claim 1, wherein said bore hole is configured with an internal airflow shape having an outside inlet diameter and tapering down to a smaller manifold inlet diameter.

15. The automotive throttle body adapter plate of claim 2, wherein said bore hole is configured with an internal airflow shape having an outside inlet diameter and tapering down to a smaller manifold inlet diameter.

16. The automotive throttle body adapter plate of claim 3, wherein said bore hole is configured with an internal airflow shape having an outside inlet diameter and tapering down to a smaller manifold inlet diameter.

17. The automotive throttle body adapter plate of claim 14, wherein said bore hole is configured with an internal airflow shape of profile 1 having an outside inlet diameter and tapering down to a smaller manifold inlet diameter.

18. The automotive throttle body adapter plate of claim 14, wherein said bore hole is configured with an internal airflow shape of profile 2 having an outside inlet diameter and tapering down to a smaller manifold inlet diameter.

19. The automotive throttle body adapter plate of claim 14, wherein said bore hole is configured with an internal airflow shape of profile 3 having an outside inlet diameter and tapering down to a smaller manifold inlet diameter.

20. An automotive throttle body adapter plate comprising:
a main body element configured with a bolt pattern on the front portion for connecting the automotive throttle body adapter plate to an automobile's intake manifold; also configured with a bolt pattern on the back portion for connecting the automotive throttle body adapter plate to a throttle body; and configured with a bore hole; further comprising a flange configured on said back portion of which said bolt pattern for connecting the automotive throttle body adapter plate to a throttle body pass through; and further comprising a gasket trough configured on said back portion and a gasket residing in said gasket trough; and further comprising a rounded corner where the outside or inlet diameter of the bore hole and said back portion meet; wherein said bore hole is also configured with an internal airflow shape having an outside inlet diameter and tapering down to a smaller manifold inlet diameter.
